(19) United States
(12) Patent Application Publication
(10) Pub. No.: US 2010/0081569 A1
(43) Pub. Date: Apr. 1, 2010

(54) COATING MATERIAL HAVING CATALYTIC ACTIVITY AND USE OF SAID COATING MATERIAL

(76) Inventors: Stefan Sepeur, Wadgassen (DE); Frank Gross, Saarlouis (DE); Gerald Frenzer, Saarbruecken (DE)

Correspondence Address: COLLARD & ROE, P.C., 1077 NORTHERN BOULEVARD, ROSLYN, NY, 11576, US

(21) Appl. No.: 12/450,635

(22) PCT Filed: Apr. 1, 2008
(86) PCT No.: PCT/DE2008/000531

§ 371 Date: Nov. 5, 2009

(30) Foreign Application Priority Data
Apr. 5, 2007 (DE) 10 2007 016 946.0
Jul. 23, 2007 (DE) 10 2007 034 633.8

(51) Int. Cl. B01J 21/06; B01J 23/10; B01J 23/58; B01J 23/02; B01J 21/02; B01J 23/04

(52) U.S. Cl. 502/243; 502/250; 502/304; 502/328; 502/330; 502/340; 502/341; 502/344

(57) ABSTRACT

The invention relates to a coating material having catalytic activity for reducing the combustion temperature of soot and organic substances. It also relates to the use of the coating material. In order to create a catalytically active coating material with which an abrasion-proof coating suitable also for optical applications can be produced for the combustion of soot and organic substances, it is proposed within the scope of the invention that the coating material contains at least 20 and less than 50 wt. % of compounds of subgroup metals or of elements of the third and fourth main groups, and between 10 and 80 wt. % of alkali or alkaline earth compounds, the molar proportion of alkali or alkaline earth compounds being higher than the molar proportion of compounds of subgroup metals or of elements of the third and fourth main groups. Surprisingly, the catalytic composition according to the invention permits the production of a colorless, transparent or translucent coating which also shows high abrasion resistance.

The invention relates to a coating material having catalytic activity for reducing the combustion temperature of soot and organic substances. It also relates to the use of the coating material.

It is known from the prior art that transition-metal oxides, in particular the oxides of Ce, La, Mn, Co, Cu and Zr, show catalytic activity with respect to the oxidation of soot and volatile organic compounds. However, the composition (e.g. mixed oxide or alloy formation) and structure (e.g. porosity and crystallinity) of these compounds have to be tailored laboriously to the application in question.

The ignition temperature for the uncatalysed spontaneous combustion of soot is about 600° C. The EP 1 355 048 A1 describes catalytically active coatings in soot-particle filters, which reduce the combustion temperature of the soot to temperatures of around 300-350° C. The catalytically active components likewise contain transition-metal oxides of the elements Ce, Zr, Mn, La, Nb or Ta. During the particle filter's regeneration phase, the coating converts the nitrogen oxides contained in the diesel exhaust gas into adsorbed nitrates. Following thermal desorption, these convert the soot particles to carbon dioxide. Zirconium oxides, especially in the form of Ce/Zr mixed oxides, are used here as additives.

The WO 03/035774 A1 describes a catalytic coating for the self-cleaning of ovens and stoves, which consists of a binder, an inorganic polymer and porous particles. The porous particles may also be transition-metal oxides. The removal of organic components is effected here by pyrolytic carbonization, i.e. combustion at temperatures above 500° C. The DE 103 14 513 A1 describes a catalyst system based on this coating for removing odorous substances on cooking, roasting, baking and grilling devices. The WO 03/027348 A2 proposes a highly porous ceramic layer showing catalytic activity at 250-320° C. for the self-cleaning of ovens and stoves. The high porosity generates a high absorption capacity, as a result of which fats, for example, are taken up, spread out or distributed, and, in combination with the catalytic activity of the coating, broken down.

The WO 00/59544 A1 describes a silane-based coating compound with catalytic, oxidative and deodorising activity. As catalytically active components, use is likewise made of transition-metal oxides. The catalytic activity of this coating compound, which is applied to a carrier, is limited to the removal of volatile organic compounds from the ambient air.

Also known from the literature is the use of alkali metals supported on metal oxides in catalytically activated diesel soot filters (E. N. Ponzi et al., Thermochim. Acta 421 (2004) 117; M. Ponzi et al., React. Kinet. Catal. Lett. 75 (2002) 63). Porous catalyst powders were tested whose ignition temperatures for soot combustion are between about 380° C. and 580° C., depending on the alkali metal. Nitrogen oxides must be supplied in addition as auxiliary oxidants.

Due to the complexity of the prior-art catalytic compositions, caused, for example, by the addition of inorganic particles, these materials have a strong inherent colour and can not be used for optical applications.

The object of this invention is to create a catalytically active coating material with which an abrasion-proof coating suitable also for optical applications can be produced for the combustion of soot and organic substances.

This object is established according to the invention by a coating material as described in the preamble, said coating material containing
between 20 and 90 wt. % of compounds of subgroup metals or of elements of the third and fourth main groups,
between 10 and 80 wt. % of alkali or alkaline earth compounds

Surprisingly, the catalytic composition according to the invention permits the production of a colourless, transparent or translucent coating which also shows high abrasion resistance. The relatively high content of alkali or alkaline earth compounds distinctly enhances the efficiency of the coating material.

An all-important advantage of the invention lies in the simple make-up of the catalytic composition.

The invention provides for the alkali or alkaline earth compounds to be selected from the group consisting of sodium, potassium, caesium and rubidium compounds.

The invention also provides for the molar proportion of alkali or alkaline earth compounds to be higher than the molar proportion of compounds of subgroup metals or of elements of the third or fourth main groups.

An embodiment of the invention consists in that the compounds of subgroup metals or of elements of the third and fourth main groups are selected from the group consisting of zirconium, aluminium, cerium, silicon, titanium, iron, germanium and gallium compounds.

It is also within the scope of the invention for the coating material to be doped with precious metals.

The activity of the coating material can be enhanced additionally by doping it with precious metals.

The invention furthermore provides for the coating material to be diluted with a solvent, especially with water, to a solids content between 0.05 and 60 wt. %, preferably between 2 and 20 wt. %.

The coating material may be applied in the diluted or undiluted state. It is also possible for the coating material to be contained as an additive in other coating materials, in particular ceramic slurries, nano-suspensions, glass frits, polymers or sol-gel systems.

Bonding to the substrate is effected by inorganic binders; it is also possible to add the active components in the form of additives to already-existing coating compounds (e.g. ceramic slurries, nano-suspensions, glass frits or sol-gel systems). The coating material of the invention may also be added to a coating system of the kind described in the DE 10 2005 021 658 A1.

Thanks to a suitable choice of binder, the inventors have succeeded in developing a non-abrasive coating. The catalytic activity of the coating is not impaired even in the case of visible abrasive damage (scratches). The catalytic combustion activity of the coating is in the range from 100 to 550° C., preferably between 250 and 400° C., and even more preferably between 250 and 350° C. The catalytic activity promotes particularly the combustion of organic substances and soot, in particular candle soot, diesel soot, model soot and volatile combustion products of wood, natural gas, petroleum and petrol.

The ignition temperature for the combustion of soot particles is between 10 and 450° C., most preferably between 250 and 350° C. These ignition temperatures can be reached without a supply of nitrogen oxides during combustion.

The scope of the invention also includes use of the coating material of the invention, the coating material being applied to a substrate and dried.

In this connection, provision is made for the substrate to be glass, metal, metalloid, metal oxide, synthetic stone, natural stone, concrete, plaster, ceramic, enamel, glass ceramic, plastic or a coated surface.

With glass as substrate, the subject of the invention can be used as a self-cleaning coating on the glass doors of fireplaces, see-through oven doors, industrial viewing glasses for combustion processes in household ovens, power plants, coking plants and steelmaking, and as anti-stick agents on glass ceramic, preferably ceramic hobs. The subject of the invention may also be used in power plants or pipes in order to prevent caking at elevated temperatures. When used as coating, or as additive in coating compounds, on other substrates, such as steel or stone, the subject of the invention has applications in power-plant stacks, combustion chambers, household chimney pipes, as coatings for grills and coatings in household appliances. Applications for diesel exhaust catalysis include coatings on engine interiors, coatings for exhaust-gas systems and for particulate filters. The material according to the invention may also be used to influence the ignition point of petrol, diesel or kerosene in the combustion chambers of engines. The coating material may furthermore be used in industry as a deodorizing catalyst or as a catalyst for chemical oxidation processes.

It is expedient that the coating material is applied to the substrate by means of a wet-chemical process, in particular by spraying, film casting, flooding, dip coating, wipe-on coating, spin coating, roll coating or printing.

It is to advantage here that the coating material is applied to give a coating thickness of between 10 nm and 100 μm, in particular between 0.5 and 20 μm.

The invention also provides for drying to be effected at a temperature in the range from room temperature to 1,000° C., in particular at a temperature between 100 and 600° C., during a period of one second to several hours.

It has proved to advantage in this connection for drying to be effected in a convection oven or under IR radiation.

A development of the invention, ultimately, consists in that drying is conducted in two stages, a lower temperature being used for pre-curing and a higher temperature being used in a second drying stage.

The coating's oxidation power is determined by visual assessment and not by customary methods such as TGA and DTA thermal analyses. To this end, a model soot dispersion (1.5% in solvent) is applied onto the coating in such manner as to cover it with a blanket of soot. Alternatively, the coating may be blanketed with candle soot. To determine the ignition temperature of the soot combustion, the coated substrate with the blanket of soot is left in an oven at different temperatures. After an hour at a temperature between 100 and 500° C., in particular between 250 and 350° C., the blanket of soot is either no longer present or flakes off, presumably as a result of dehesion caused by oxidation of the undermost soot layer. If the coated substrate is left in the oven for longer periods (2-5 hours), this combustion temperature is reduced significantly.

The invention is explained in detail below by reference to embodiments.

### EXAMPLE 1

2.27 g (3-glycidoxypropyl)triethoxysilane (GPTES) and 1.51 g silica sol (Levasil 200s) are stirred for one hour. 3.77 g zirconium acetylacetonate, 0.99 g sodium nitrate and 41.9 g water are added to this solution and the mixture stirred overnight.

### EXAMPLE 2

5.0 g aluminium oxide C (mean primary-particle size=13 nm) are dispersed in 95.0 g of 5% acetic acid with an Ultra-Turrax disperser for 10 minutes at 15,000 rpm. 5.5 g of a TEOS hydrolysate (prepared by stirring 28.0 g TEOS and 10 g 0.01M hydrochloric acid until a clear solution was obtained) are stirred into the dispersion. After an hour's stirring, 70.2 g zirconium acetate (30% in water) and 0.92 g Sr(NO₃)₂ are added. The pH of the solution is adjusted to pH 3 with approx. 14.0 g 10% acetic acid.

### EXAMPLE 3

1.04 g diacetone alcohol and 30 mg propionic acid are added to 4.34 g cerium(III) nitrate*6 H₂O and 1.28 g sodium nitrate in 19.8 g ethanol. The solution is stirred overnight and is ready for coating.

### EXAMPLE 4

51.4 g water and 6.68 g potassium acetate are added to 1.12 g (3-glycidoxypropyl)triethoxysilane (GPTES) and 1.20 g silica sol (Levasil 200s). After the potassium salt has been stirred in, 2.00 g TiO₂ (Degussa P25) are added and dispersed with an Ultra-Turrax for 30 minutes at 15,000 rpm. The dispersion can be applied directly. The solutions from Examples 1 to 4 are applied to a glass substrate (example 1) or a steel substrate (Examples 2 to 4) and dried for one hour at 500° C. (heating rate=2° C./min) in a muffle furnace. Pre-curing may be effected at lower temperatures. On glass, a non-abrasive, transparent or translucent coating is obtained.

To assess the soot degradation, a dispersion of model soot is applied by flooding to the coatings from Examples 1 and 2. Alternatively, the coatings may be blanketed with candle soot. To prepare the soot dispersion, 1.8 g Degussa Printex U is added to 60 g isopropanol and dispersed with an Ultra-Turrax for one minute at 15,000 rpm. The substrates are then exposed to test conditions in a muffle furnace. On glass, the soot is degraded completely at temperatures between 100 and 500° C., preferably between 250 and 430° C. On steel, the soot is degraded at temperatures between 100 and 450° C., preferably between 250 and 400° C.

1-13. (canceled)

14. Coating material having catalytic activity for reducing the combustion temperature of soot and organic substances, wherein the coating material contains
at least 20 and less than 50 wt. % of compounds of subgroup metals or of elements of the third and fourth main groups,
between 10 and 80 wt. % of alkali or alkaline earth compounds,
the molar proportion of alkali or alkaline earth compounds being higher than the molar proportion of compounds of subgroup metals or of elements of the third or fourth main groups.

15. Coating material according to claim 14, wherein the alkali or alkaline earth compounds are selected from the group consisting of sodium, potassium, caesium and rubidium compounds.

16. Coating material according to claim 14, wherein the compounds of subgroup metals or of elements of the third or fourth main groups are selected from the group consisting of zirconium, aluminium, cerium, silicon, titanium, iron, germanium and gallium compounds.

17. Coating material according to claim 14, wherein the coating material is diluted with a solvent, especially with water, to a solids content between 0.05 and 60 wt. %, preferably between 2 and 20 wt. %.

18. Coating material according to claim 14, wherein the coating material can be applied in the diluted or undiluted state.

19. Use of the coating material according to claim 14, wherein the coating material is applied to a substrate and dried.

20. Use according to claim 19, wherein the substrate is glass, metal, metalloid, metal oxide, synthetic stone, natural stone, concrete, plaster, ceramic, enamel, glass ceramic, plastic or a coated surface.

21. Use according to claim 19, wherein the coating material is applied to the substrate by means of a wet-chemical process, in particular by spraying, film casting, flooding, dip coating, wipe-on coating, spin coating, roll coating or printing.

22. Use according to claim 19, wherein the coating material is applied to give a coating thickness of between 10 nm and 100 μm, in particular between 0.5 and 20 μm.

23. Use according to claim 19, wherein drying is effected at a temperature in the range from about room temperature to 1,000° C., in particular at a temperature between 100 and 600° C., during a period of one second to several hours.

24. Use according to claim 19, wherein drying is effected in a convection oven or under IR radiation.

25. Use according to claim 19, wherein drying is conducted in two stages, a lower temperature being used for pre-curing and a higher temperature being used in a second drying stage.

26. Use of the coating material according to claim 14 for producing coatings
on the engine interiors, pistons, exhaust-gas systems and exhaust-gas filters, especially diesel particulate filters, of internal combustion engines,
on panes, machine parts, pipes or power-plant components,
in chimney interiors and combustion chambers, in particular for glass and steel inserts and for chimney stones and filter mats,
as deslagging agents in power plants,
as anti-stick agents on see-through oven doors, grilling devices, household appliances and hotplates, in particular ceramic hobs,
on a carrier for the removal of volatile organic compounds from indoor ambient air, especially after concentration on the coating, or
to catalyze chemical oxidation processes in industrial applications.
